(19) United States
(12) Patent Application Publication
(10) Pub. No.: US 2013/0260013 A1
(43) Pub. Date: Oct. 3, 2013

(54) COMESTIBLE PRODUCTS AND METHODS OF MAKING THE SAME

(71) Applicant: John David Crooch, Chicago, IL (US)

(72) Inventor: John David Crooch, Chicago, IL (US)

(21) Appl. No.: 13/800,528

(22) Filed: Mar. 13, 2013

Related U.S. Application Data
(60) Provisional application No. 61/617,290, filed on Mar. 29, 2012.
(60) Provisional application No. 61/645,804, filed on May 11, 2012.

(51) Int. Cl. A23L 1/29

(52) U.S. Cl. CPC A23L 1/296
USPC 426/640; 426/531; 426/656; 426/658; 426/659; 426/650

(57) ABSTRACT

Comestible products and methods of making the same are provided. In one aspect, a comestible product includes a composition comprising at least two of a dried protein, a dried vegetable, a dried fruit, a dried broth, a carbohydrate, and a flavoring. In another aspect, a comestible product includes a composition comprising, as a percentage by weight, between about 60% and about 98% of a dried product, between about 2% and about 40% of a flavoring, and the composition, as a percentage by weight, does not exceed 100%.

### RELATED APPLICATIONS

The present application claims the benefit of co-pending U.S. Provisional Patent Application Nos. 61/617,290, filed Mar. 29, 2012, and 61/645,804, filed May 11, 2012, the entire contents of all of which are incorporated herein by reference

### FIELD OF THE INVENTION

This disclosure generally relates to comestible products and methods of making comestible products and, more particularly, to comestible products including at least one of a dried product and flavoring, and methods of making such comestible products.

### BACKGROUND

People are becoming more conscientious about products they consume. Moreover, individuals particularly concerned about consuming healthy foods or foods particularly adapted to their lifestyle are interested in comestible products that both satisfy their health needs and taste pleasurable. In some instances, people desire a comestible product such as, for example, a dietary supplement, a protein shake, meal replacement product, protein bar, meal replacement bar, etc. These and other comestible products today usually sacrifice one or the other of healthiness or taste.

### SUMMARY

In some examples, a comestible product is provided.

In other examples, a method of making a comestible product is provided.

In yet other examples, a comestible product is provided and includes a composition comprising a dried product and a flavoring.

In still other examples, a method of making a comestible product is provided and includes providing a dried product, providing a flavoring, and combining the dried product and the flavoring.

In further examples, a comestible product is provided and includes a composition comprising a dried protein, a dried vegetable, and a flavoring. A method of making such a comestible product is also provided.

In yet further examples, a comestible product is provided and includes a composition comprising, as a percentage by weight, between about 40 percent and about 60 percent of a dried protein and between about 40 percent and about 60 percent of a dried vegetable.

In still further examples, a comestible product is provided and includes a composition comprising, as a percentage by weight, between about 0.01 percent and about 99.98 percent of a dried protein, between about 0.01 percent and about 99.98 percent of a dried vegetable, and between about 0.01 percent and about 99.98 percent of a flavoring.

In other examples, a comestible product is provided and includes a composition comprising a proportion of carbohydrate, a proportion of one or more of dried protein, dried vegetable, and/or dried fruit, and a dried flavoring.

In yet other examples, a comestible product is provided and includes a composition comprising a proportion of dried broth and a flavoring.

In still other examples, a comestible product is provided and includes a composition comprising a proportion of dried meat, a proportion of dried broth and flavoring.

In further examples, a comestible product is provided and includes a composition comprising multiple sources of dried protein and flavoring.

In yet further examples, a comestible product is provided and includes a composition comprising at least two of a dried protein, a dried vegetable, a dried fruit, a dried broth, a carbohydrate, and a flavoring. The composition may comprise at least three of the dried protein, the dried vegetable, the dried fruit, the dried broth, the carbohydrate, and the flavoring. The composition may comprise at least four of the dried protein, the dried vegetable, the dried fruit, the dried broth, the carbohydrate, and the flavoring. The composition may comprise the dried protein, the dried vegetable, and the flavoring. The composition may comprise, as a percentage by weight, between about 30% and about 91% of the dried protein, between about 10% and about 50% of the dried vegetable, between about 3% and about 40% of the flavoring, and the composition, as a percentage by weight, does not exceed 100%. The flavoring may be comprised of a sweetener and a flavoring. The composition may comprise, as a percentage by weight, between about 70% and about 91% of the dried protein, between about 10% and about 21%% of the dried vegetable, between about 4% and about 10% of the flavoring, and the composition, as a percentage by weight, does not exceed 100%. The composition may further comprise, as a percentage by weight, between about 2% and about 3% of the dried broth. The flavoring may be comprised of a sweetener and a flavoring. The composition may comprise, as a percentage by weight, between about 30% and about 91% of the dried protein, between about 2% and about 50% of the dried broth, between about 3% and about 40% of the flavoring, and the composition, as a percentage by weight, does not exceed 100%. The composition may comprise, as a percentage by weight, between about 87% and about 91% of the dried protein, between about 2% and about 3% of the dried broth, between about 6% and about 10% of the flavoring, and the composition, as a percentage by weight, does not exceed 100%. The flavoring may comprise, as a percentage of weight of the composition, between about 0.06% and about 0.14% of a sweetener.

In still further examples, a comestible product is provided and includes a composition comprising, as a percentage by weight, between about 60% and about 98% of a dried product, between about 2% and about 40% of a flavoring, and the composition, as a percentage by weight, does not exceed 100%. The dried product may be one of a dried protein, a dried vegetable, and dried fruit. The dried product may be at least two of a dried protein, a dried vegetable, and a dried fruit. The flavoring may be at least one of a natural ingredient, an artificial ingredient, a spice, a sweetener, chocolate, vanilla, mocha, caramel, peanut butter, cranberry, strawberry, banana, mint chocolate, cookies and cream. As a percentage by weight of the composition, the dried product may be between about 75% and about 85% and the flavoring may be between about 15% and about 25%. The dried product may be comprised of, as a percentage by weight of the composition, between about 70% and about 73% of a dried protein, and between about 19% and about 21% of a dried vegetable. The composition may further comprises, as a percentage by weight, between about 0.10% and about 0.12% of a sweetener, and between about 2% and about 3% of a dried broth, and the flavoring may be, as a percentage by weight of the composition, between about 4% and about 8%. The sweetener may be comprised of, as a percentage by weight of the composition, between about 0.05% and about 0.06% of a first sweetener, between about 0.05% and about 0.06% of a second sweetener, and the first sweetener and the second sweetener may be different types of sweeteners. The dried product may be a dried protein and may be, as a percentage by weight of the composition, between about 87% and about 91%, and the composition may further comprises, as a percentage by weight, between about 0.13% and about 0.14% of a sweetener, and between about 2% and about 3% of dried broth, and the flavoring may be, as a percentage by weight of the composition, between about 6% and about 10%. The sweetener may be comprised of, as a percentage by weight of the composition, between about 0.065% and about 0.070% of a first sweetener, between about 0.065% and about 0.070% of a second sweetener, and the first sweetener and the second sweetener may be different types of sweeteners.

### BRIEF DESCRIPTION OF THE DRAWINGS

Certain embodiments of the present are illustrated by the accompanying figures. It should be understood that the figures are not necessarily to scale and that details that are not necessary for an understanding of the disclosure or that render other details difficult to perceive may be omitted. It should be understood, of course, that the disclosure is not necessarily limited to the particular embodiments illustrated herein.

FIG. 1 is a flowchart of an exemplary process of making an exemplary comestible product; and

FIG. 2 is a flowchart of another exemplary process of making another exemplary comestible product.

Before any independent features and embodiments of the disclosure are explained in detail, it is to be understood that the disclosure is not limited in its application to the details of the construction and the arrangement of the components set forth in the following description or illustrated in the drawings. The disclosure is capable of other embodiments and of being practiced or of being carried out in various ways. Also, it is understood that the phraseology and terminology used herein is for the purpose of description and should not be regarded as limiting.

### DETAILED DESCRIPTION

People are becoming more conscientious about products they consume. Moreover, individuals particularly concerned about consuming healthy foods or foods particularly adapted to their lifestyle are interested in comestible products that both satisfy their health needs and taste pleasurable. In some instances, people desire a comestible product such as, for example, a dietary supplement, a protein shake, meal replacement product, protein bar, meal replacement bar, etc. These and other comestible products today usually sacrifice one or the other of healthiness or taste. Thus, a need exists for a comestible product that is both healthy and has a pleasurable taste.

Comestible products of the present disclosure may have a variety of different compositions including a variety of different components. The comestible products disclosed herein are for exemplary purposes and are not intended to be limiting upon the possibilities of the present disclosure. Moreover, the comestible products of the present disclosure are capable of including other compositions and all of such possibilities are intended to be within the spirit and scope of the present disclosure. Likewise, the present disclosure may include a wide variety of different methods of making such comestible products. The methods disclosed herein are for exemplary purposes and are not intended to be limiting upon the possibilities of the present disclosure. The present disclosure is capable of including other methods of making comestible products and all of such possible methods are intended to be within the spirit and scope of the present disclosure.

In some exemplary embodiments, a comestible product may include a dried comestible product such as, for example, a dried protein, a dried vegetable, a dried fruit, dried broth, etc. Dried proteins may be any type of protein such as, for example, beef, lamb, buffalo, chicken, egg, fish, ostrich, bison, tuna, turkey, or any other type of meat, fish, or fowl, etc. Additionally, dried vegetables may be any type of vegetable such as, for example, green beans, kale, peas, broccoli, spinach, cabbage, lettuce, carrots, zucchini, squash, asparagus, etc. Further, dried fruits may be any type of fruit such as, for example, cranberries, strawberries, bananas, raspberries, blackberries, blueberries, pineapple, apples, mangos, pomegranates, cantaloupe, honeydew, acai, grapes, pears, lemons, oranges, limes, etc. Dried broths may be any type of dried broths.

Proteins, vegetables, fruits, broths, and other components of the compositions of the comestible products may be dried or dehydrated in any manner. For example, these products may be freeze dried, spray dried, drum dried, solar dried, oven dried, electric dehydrator dried, etc. It should be understood these are only exemplary manners of drying and are not intended to be limiting upon the present disclosure. Rather, other types of drying are intended to be within the spirit and scope of the present disclosure.

In some exemplary embodiments, a comestible product may be comprised of only a single dried product. For example, such a comestible product may have a composition comprising, as a percentage by weight, 100 percent of a dried protein, 100 percent of a dried vegetable, 100 percent of a dried fruit, or 100 percent of a dried broth.

In other exemplary embodiments, a comestible product may be comprised of a combination of two or more of a dried protein, a dried vegetable, and a dried fruit. For example, the comestible product may include: 1) a dried protein and a dried vegetable; 2) a dried protein and a dried fruit; 3) a dried vegetable and a dried fruit; or 4) a dried protein, a dried vegetable, and a dried fruit. The compositions of such comestible products may comprise, as a percentage by weight, any proportion of two or more of a dried protein, a dried vegetable, and/or a dried fruit.

In further exemplary embodiments, a comestible product may include flavoring in addition to one or more of a dried protein, a dried vegetable, and/or a dried fruit. The composition of such a comestible product may comprise, as a percentage by weight, a proportion of flavoring and a proportion of one or more of the dried products. For example, such a composition may comprise, as a percentage by weight, of: 1) a proportion of flavoring and a proportion of dried protein; 2) a proportion of flavoring and a proportion of dried vegetable; 3) a proportion of flavoring and a proportion of dried fruit; 4) a proportion of flavoring, a proportion of dried protein, and a proportion of dried vegetable; 5) a proportion of flavoring, a proportion of dried protein, and a proportion of dried fruit; 6) a proportion of flavoring, a proportion of dried vegetable, and a proportion of dried fruit; and 7) a proportion of flavoring, a proportion of dried protein, a proportion of dried vegetable, and a proportion of dried fruit. Additionally, the compositions of such comestible products may comprise, as a percentage by weight, any proportion of flavoring and any proportion of one or more of a dried protein, a dried vegetable, and/or a dried fruit.

Flavoring may be a wide variety of different products such as, for example, dried comestible products, natural ingredients, artificial ingredients, spices, sweeteners, etc., and may be provided in a wide variety of forms such as, for example, powders, liquids, plasmas, etc. Any type of flavoring may be used and the following is only a partial list of possible flavorings: Chocolate, vanilla, mocha, caramel, peanut butter, cranberry, strawberry, banana, mint chocolate, cookies and cream, sweeteners, etc. The exemplary flavorings described herein are not intended to be limiting. Rather, the comestible products of the present disclosure are intended to be able to use any type of flavoring and all of such flavorings are intended to be within the spirit and scope of the present disclosure.

In still other exemplary embodiments, a comestible product may include a carbohydrate in addition to one or more of a dried protein, a dried vegetable, and/or a dried fruit, and/or a flavoring. The carbohydrate may be dried or may not be dried. The carbohydrate is capable of being any type of carbohydrate. Some exemplary carbohydrates include, but are not limited to, rice, potatoes, sweet potatoes, oats, wheat, quinoa, amaranth, barley, buckwheat, corn, flax kamut, millet, rye, spelt, triticale, grains, flour, etc. The composition of such a comestible product may comprise a proportion of carbohydrate, a proportion of one or more of the dried products, and a proportion of flavoring. For example, such a composition may comprise, as a percentage by weight, of: 1) a proportion of carbohydrate and a proportion of dried protein; 2) a proportion of carbohydrate and a proportion of dried vegetable; 3) a proportion of carbohydrate and a proportion of dried fruit; 4) a proportion of carbohydrate and a proportion of flavoring; 5) a proportion of carbohydrate, a proportion of dried protein, and a proportion of dried vegetable; 6) a proportion of carbohydrate, a proportion of dried protein, and a proportion of dried fruit; 7) a proportion of carbohydrate, a proportion of dried protein, and a proportion of flavoring; 8) a proportion of carbohydrate, a proportion of dried vegetable, and a proportion of dried fruit; 9) a proportion of carbohydrate, a proportion of dried vegetable, and a proportion of flavoring; 10) a proportion of carbohydrate, a proportion of dried fruit, and a proportion of flavoring; 11) a proportion of carbohydrate, a proportion of dried protein, a proportion of dried vegetable, and a proportion of dried fruit; 12) a proportion of carbohydrate, a proportion of dried protein, a proportion of dried vegetable, and a proportion of flavoring; 13) a proportion of carbohydrate; a proportion of dried vegetable, a proportion of dried fruit, and a proportion of flavoring; and 14) a proportion of carbohydrate, a proportion of dried protein, a proportion of dried vegetable, a proportion of dried fruit, and a proportion of flavoring. It should be understood that such compositions of comestible products may include, as a percentage by weight, any proportion of carbohydrate, any proportion of one or more of a dried protein, a dried vegetable, and/or a dried fruit, and any proportion of flavoring.

The exemplary comestible products of the present disclosure may have any form and the element or elements of the compositions of the comestible products may have any size. For example, the element(s) of the composition may be powder size (e.g., between about 0.00015 inches and about 0.5 inches in width or diameter), chunks (e.g., between about 0.5 inches and about 1 inch in width or diameter), etc. Also, for example, the composition may be substantially dry, or may be wet and include a liquid or semi-liquid to provide the overall composition of the comestible product as a gel or liquid. In examples where the comestible product is a gel or liquid, the comestible product may have any viscosity and be within the intended spirit and scope of the present disclosure. In further examples, the comestible product may be in bar form or in a semi-hard form. In such examples, the composition of the comestible product includes necessary elements to allow the elements of the comestible product to stick or otherwise compact and remain together such as, for example, honey, sugar based liquids, gels, or other appropriately viscous and sticky elements.

In some exemplary embodiments, a comestible product may be in powder form and the element or all the elements of the composition are in powder form. The element(s) of such a comestible product may already be in powder form or may require manipulation to transform the element(s) into a powder. A variety of different processes may be utilized to transform the element(s) into a powder such as, for example, a food processor, blender, mills, hammer mills, disk millers, sieves, mesh, grinders, mortar and pestle, etc. For example, if one of the composition elements of the comestible product is dried protein, the dried protein may be introduced into a food processor until the dried protein is transformed into a desired size of powder for the composition of the comestible product. Comestible products in powder form may be consumed in the powder form directly, sprinkled on other comestible products, or combined with one or more of a variety of liquids such as, for example, water, milk, juice, etc. The powder of the comestible product may be added to a liquid in any proportion.

Comestible products of the present disclosure may be provided by a variety of different processes and all of such processes are intended to be within the spirit and scope of the present disclosure. Additionally, processes of the present disclosure are capable of having any number of steps and steps may be performed in any order. The following processes are exemplary processes for providing exemplary comestible products and are not intended to be limiting.

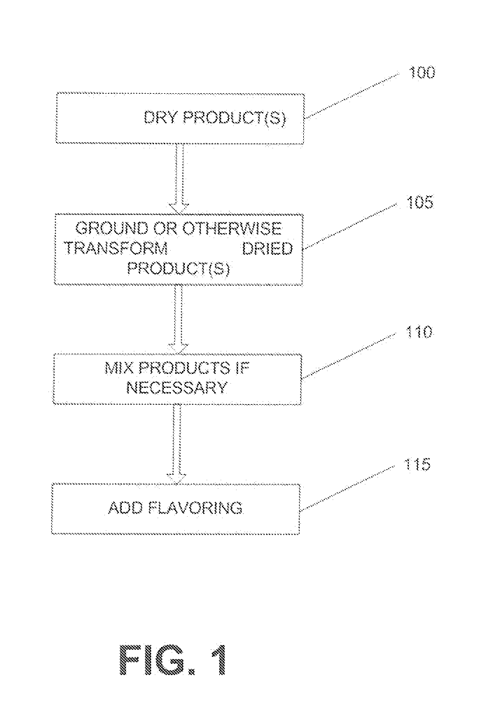

In some exemplary embodiments, a comestible product is provided in powder form by an exemplary process such as that illustrated in FIG. 1. Such an exemplary process may include drying a protein such as, for example, chicken, and drying a vegetable such as, for example, green beans 100. Such drying may be performed in any of the manners described above or any other manner of drying. After drying, the exemplary chicken and green beans are ground or otherwise transformed into a powder 105. Transformation of the dried products into powder may be performed in a variety of manners such as, for example, a food processor. The exemplary chicken and green beans may be transformed into powder separately and then mixed together 110, or the chicken and green beans may be mixed together 110 then transformed into powder simultaneously. A flavoring may be added 115 to the composition at any time in the process. The flavoring may already be in powder form so may not require transformation into a powder. In other instances, the flavoring may also be required to be transformed into powder. In such instances, the flavoring may be transformed into powder at any time in the process. The comestible product is provided in its powder form when the dried products and the flavoring are in powder form and are mixed together.

In some exemplary embodiments, a comestible product may be in liquid form and the composition of such a liquid comestible product comprises a proportion of at least one element in solid form and a proportion of liquid. The liquid comestible product may comprise any proportion of solids and any proportion of liquid resulting in any possible viscosity and all of such possibilities are intended to be within the spirit and scope of the present disclosure. Similar to above, the solids and liquids of the comestible product may be any of the types of solids and liquids disclosed herein or other solids and liquids.

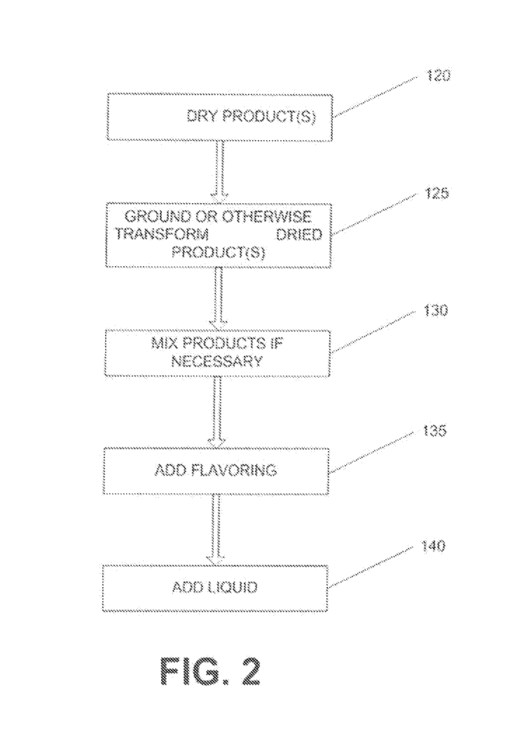

In some exemplary embodiments, a comestible product is provided in liquid form by an exemplary process such as that illustrated in FIG. 2. Such an exemplary process may include drying a protein such as, for example, beef, and drying a vegetable such as, for example, broccoli 120. Such drying may be performed in any of the manners described above or any other manner of drying. After drying, the exemplary beef and broccoli are ground or otherwise transformed into a powder 125. Transformation of the dried products into powder may be performed in a variety of manners such as, for example, a food processor. The exemplary beef and broccoli may be transformed into powder 125 separately and then mixed together 130, or the beef and broccoli may be mixed together 130 than transformed into powder 125 simultaneously. A flavoring may be added 135 to the composition at any time in the process. The flavoring may already be in powder form so may not require transformation into a powder. In other exemplary embodiments, the flavoring may also be required to be transformed into powder. In such exemplary embodiments, the flavoring may be transformed into powder at any time in the process. A liquid is provided and may be added 140 to the composition at any time in the process. In some instances, the powder elements of the composition may be provided and mixed together completely, then introduced into the liquid. In other instances, the powder elements may be introduced into the liquid individually after transformation of the elements into powder. After introduction of the powder elements into the liquid element, the composition is mixed together using any mixing process. The composition may be mixed after combination of all elements or the composition may be mixed after introduction of each powder element. The comestible product is provided in its liquid form when all the powder elements and the liquid elements are combined and mixed.

As indicated above, the comestible products of the present disclosure may have a wide variety of compositions comprising a wide variety of elements in a wide variety of properties. The following exemplary compositions are only a sample of the many possible compositions, are presented for exemplary purposes, and are not intended to be limiting upon the present disclosure.

In some exemplary embodiments, a comestible product includes a composition comprising, as a percentage by weight, about 100 percent of a single type of dried product. The single type of dried product may be any type of protein, vegetable, fruit, or broth

In other exemplary embodiments, a comestible product includes a composition comprising, as a percentage by weight, about 100 percent of multiple types of dried products. The multiple types of dried products may be any type of dried products, any number of dried products, and combined in any proportion. In some examples, the composition of such a dried product may comprise, as a percentage by weight, about 60 percent dried protein and about 40 percent dried vegetable. In other examples, the composition of such a dried product may comprise, as a percentage by weight, about 50 percent dried protein and about 50 percent dried vegetable. In further examples, the composition of such a dried product may comprise, as a percentage by weight, between about 40 percent and 60 percent dried protein and between about 40 percent and 60 percent dried vegetable. In yet other examples, the composition of such a dried product may comprise, as a percentage by weight, between about 0.01 percent and about 99.99 percent dried protein and between about 0.01 percent and 99.99 percent dried vegetable. The above exemplary compositions may also apply to combinations of dried protein or dried vegetables with dried fruit. In still other examples, a composition may comprise about 30 grams of a dried protein such as, for example, meat, and about 8.33 grams of a dried vegetable such as, for example, spinach. Such an exemplary composition comprises, as a percentage by weight, about 78.3 percent dried protein and about 21.7 percent dried vegetable.

In further exemplary embodiments, a comestible product includes a composition comprising a combination of a single type of dried product and flavoring. The single type of dried product may be any type of dried product and may be combined with the flavoring in any proportion. In some examples, the composition of such a comestible product may comprise, as a percentage by weight, about 80 percent of a single type of dried product and about 20 percent of a flavoring. In other examples, the composition of such a comestible product may comprise, as a percentage by weight, between about 60 percent and about 95 percent of a single type of dried product and between about 5 percent and about 40 percent of a flavoring. In further examples, the composition of such a comestible product may comprise, as a percentage by weight, between about 0.01 percent and about 99.99 percent of a dried product and between about 0.01 percent and about 99.99 percent flavoring.

In still other exemplary embodiments, a comestible product includes a composition comprising a combination of multiple types of dried products and flavoring. The multiple types of dried products may be any type of dried products, any number of dried products, and combined in any proportion. Moreover, the flavoring may be any type of flavoring. In some examples, the composition of such a comestible product may comprise, as a percentage by weight, about 50 percent of a first type of dried product, about 30 percent of a second type of dried product, and about 20 percent of a flavoring. In other examples, the composition of such a comestible product may comprise, as a percentage by weight, between about 30 percent and about 70 percent of a first dried product, between about 10 percent and about 50 percent of a second dried product, and between about 5 percent and about 40 percent flavoring. In further examples, the composition of such a comestible product may comprise, as a percentage by weight, between about 0.01 percent and about 99.98 percent of a first dried product, between about 0.01 and about 99.98 percent of a second dried product, and between about 0.01 percent and about 99.98 percent flavoring.

In still further exemplary embodiments, a comestible product includes a composition comprising a single type of dried product and a liquid. The single type of dried product may be any type of dried product and may be combined with the liquid in any proportion. Moreover, the liquid may be any type of liquid. In some examples, the composition of such a comestible product may comprise, as a percentage by weight, about 40 percent of a single type of dried product and about 60 percent of liquid. In other examples, the composition of such a comestible product may comprise, as a percentage by weight, between about 20 percent and about 60 percent of a dried product and between about 40 percent and about 80 percent liquid. In further examples, the composition of such a comestible product may comprise, as a percentage by weight, between about 0.01 percent and about 99.99 percent of a dried product and between about 0.01 percent and about 99.99 percent liquid.

In yet other exemplary embodiments, a comestible product includes a composition comprising multiple types of dried products and a liquid. The multiple types of dried products may be any type of dried products, any number of dried products, and combined in any proportion with themselves and with the liquid. Moreover, the liquid may be any type of liquid. In some examples, the composition of such a comestible product may comprise, as a percentage by weight, about 25 percent of a first type of dried product, about 15 percent of a second type of dried product, and about 60 percent of liquid. In other examples, the composition of such a comestible product may comprise, as a percentage by weight, between about 5 percent and about 45 percent of a first dried product, between about 5 percent and about 35 percent of a second dried product, and between about 40 percent and about 80 percent liquid. In further examples, the composition of such a comestible product may comprise, as a percentage by weight, between about 0.01 percent and about 99.98 percent of a first dried product, between about 0.01 percent and about 99.98 percent of a second dried product, and between about 0.01 percent and about 99.98 percent liquid.

In yet further exemplary embodiments, a comestible product includes a composition comprising a single type of dried product, flavoring, and a liquid. The single type of dried product may be any type of dried product and may be combined with the flavoring and liquid in any proportion. Moreover, the flavoring may be any type of flavoring and the liquid may be any type of liquid. In some examples, the composition of such a comestible product may comprise, as a percentage by weight, about 32 percent of a single type of dried product, about 8 percent of a flavoring, and about 60 percent of liquid. In other examples, the composition of such a comestible product may comprise, as a percentage by weight, between about 10 percent and about 55 percent of a dried product, between about 1 percent and about 30 percent flavoring, and between about 35 percent and about 85 percent liquid. In further examples, the composition of such a comestible product may comprise, as a percentage by weight, between about 0.01 percent and about 99.98 percent of a dried product, between about 0.01 percent and about 99.98 percent flavoring, and between about 0.01 percent and about 99.98 percent liquid.

In other exemplary embodiments, a comestible product includes a composition comprising multiple types of dried products, flavoring, and liquid. The multiple types of dried products may be any type of dried products, any number of dried products, and combined in any proportion with themselves, the flavoring, and the liquid. Moreover, the flavoring may be any type of flavoring and the liquid may be any type of liquid. In some examples, the composition of such a comestible product may comprise, as a percentage by weight, about 20 percent of a first type of dried product, about 12 percent of a second type of dried product, about 8 percent of a flavoring, and about 60 percent of a liquid. In other examples, the composition of such a comestible product may comprise, as a percentage by weight, between about 5 percent and about 40 percent of a first dried product, between about 2 percent and about 35 percent of a second dried product, between about 1 percent and about 30 percent flavoring, and between about 35 percent and 85 percent liquid. In further examples, the composition of such a comestible product may comprise, as a percentage by weight, between about 0.01 percent and about 99.97 percent of a first dried product, between about 0.01 percent and about 99.97 percent of a second dried product, between about 0.01 percent and about 99.97 percent flavoring, and between about 0.01 percent and 99.97 percent liquid.

In further exemplary embodiments, a comestible product may include a composition comprised of any of the elements or components disclosed herein in any proportion and combination. Thus, the permutations are numerous and too extensive to provide an exhaustive list herein. However, all such permutations and possibilities are intended to be within the spirit and scope of the present disclosure. The following examples are only a few of the numerous possibilities of compositions and are not intended to be limiting.

In one example, a comestible product includes a composition comprising about 30 grams of dried protein, about 0.023 grams of a first sweetener, about 0.023 grams of a second sweetener, about 0.95 grams of dried broth, and about 2 grams of flavoring. In some instances, the sweeteners may be considered as flavoring and may be grouped with the flavoring, however, for purposes of this example, the sweeteners are separately identified. Additionally, the two sweeteners may be grouped together and identified collectively as a single sweetener, however, for the purposes of this example, the sweeteners are individually identified. Exemplary sweeteners include, but are not limited to, acesulfame-k and sucralose. In such an example, this composition comprises, as a percentage by weight, about 90.92 percent dried protein, about 0.07 percent a first sweetener, about 0.07 percent a second sweetener, about 2.88 percent dried broth, and about 6.06 percent flavoring.

In another example, a comestible product includes a composition comprising about 30 grams of dried protein, about 0.023 grams of a first sweetener, about 0.023 grams of a second sweetener, about 0.95 grams of dried broth, and about 3.32 grams of flavoring. Similar to above, the sweeteners may be considered as flavoring and grouped with the flavoring, may be grouped together as a single sweetener, or may be identified individually. In such an example, this composition comprises, as a percentage by weight, about 87.42 percent dried protein, about 0.067 percent a first sweetener, about 0.067 percent a second sweetener, about 2.77 percent dried broth, and about 9.676 percent flavoring. Moreover, other examples of comestible products may include compositions including similar quantities, and associated percentage by weight breakdowns, of dried protein, a first sweetener, a second sweetener, dried broth, and any quantity of flavoring between about 2 grams and about 3.32 grams.

In a further example, a comestible product includes a composition comprising about 30 grams of dried protein, about 8.33 grams of dried vegetable, about 0.023 grams of a first sweetener, about 0.023 grams of a second sweetener, about 0.95 grams of dried broth, and about 2 grams of flavoring. Similar to above, the sweeteners may be considered as flavoring and grouped with the flavoring, may be grouped together as a single sweetener, or may be identified individually. In such an example, this composition comprises, as a percentage by weight, about 72.59 percent dried protein, about 20.16 percent of dried vegetable, about 0.056 percent of a first sweetener, about 0.056 percent a second sweetener, about 2.30 percent dried broth, and about 4.84 percent flavoring.

In still another example, a comestible product includes a composition comprising about 30 grams of dried protein, about 8.33 grams of dried vegetable, about 0.023 grams of a first sweetener, about 0.023 grams of a second sweetener, about 0.95 grams of broth, and about 3.32 grams of flavoring. Similar to above, the sweeteners may be considered as flavoring and grouped with the flavoring, may be grouped together as a single sweetener, or may be identified individually. In such an example, this composition comprises, as a percentage by weight, about 70.35 percent dried protein, about 19.53 percent dried vegetable, about 0.054percent a first sweetener, about 0.054 percent a second sweetener, about 2.23 percent dried broth, and about 7.79 percent flavoring. Moreover, other examples of comestible products may include compositions including similar quantities, and associated percentage by weight breakdowns, of dried protein, dried vegetable, a first sweetener, a second sweetener, dried broth, and any quantity of flavoring between about 2 grams and about 3.32 grams.

As can be seen, any combination of any elements or components described herein, and alternatives and equivalents thereof, is possible and all of such combinations and possibilities are intended to be within the spirit and scope of the present disclosure.

It should be understood that a variety of exemplary compositions are possible as a result of the present disclosure and some of such compositions include multiple elements or components with each element or component capable of having a wide range of possible weight percentages of the composition, but it also being understood that the sum or total percentages by weight of all the elements and components equals 100 percent. Additionally, the compositions may include trace amounts of other elements with the sum of all parts equaling 100 percent.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The foregoing description has been presented for purposes of illustration and description, and is not intended to be exhaustive or to limit the disclosure to the precise form disclosed. The descriptions were selected to explain the principles of the disclosure and their practical application to enable others skilled in the art to utilize the disclosure in various embodiments and various modifications as are suited to the particular use contemplated. Although particular constructions of the present disclosure have been shown and described, other alternative constructions will be apparent to those skilled in the art and are within the intended scope of the present disclosure.

What is claimed is:

1. A comestible product including a composition comprising, as a percentage by weight:
between about 60% and about 98% of a dried product; and
between about 2% and about 40% of a flavoring;
wherein the composition, as a percentage by weight, does not exceed 100%.

2. The comestible product of claim 1, wherein the dried product is one of a dried protein, a dried vegetable, and dried fruit.

3. The comestible product of claim 1, wherein the dried product is at least two of a dried protein, a dried vegetable, and a dried fruit.

4. The comestible product of claim 1, wherein the flavoring is at least one of a natural ingredient, an artificial ingredient, a spice, a sweetener, chocolate, vanilla, mocha, caramel, peanut butter, cranberry, strawberry, banana, mint chocolate, cookies and cream.

5. The comestible product of claim 1, wherein, as a percentage by weight of the composition, the dried product is between about 75% and about 85% and the flavoring is between about 15% and about 25%.

6. The comestible product of claim 1, wherein the dried product is comprised of, as a percentage by weight of the composition:
between about 70% and about 73% of a dried protein; and
between about 19% and about 21% of a dried vegetable.

7. The comestible product of claim 6, wherein the composition further comprises, as a percentage by weight:
between about 0.10% and about 0.12% of a sweetener; and
between about 2% and about 3% of a dried broth;
wherein the flavoring is, as a percentage by weight of the composition, between about 4% and about 8%.

8. The comestible product of claim 7, wherein the sweetener is comprised of, as a percentage by weight of the composition:
between about 0.05% and about 0.06% of a first sweetener; and
between about 0.05% and about 0.06% of a second sweetener;
wherein the first sweetener and the second sweetener are different types of sweeteners.

9. The comestible product of claim 1, wherein the dried product is a dried protein and is, as a percentage by weight of the composition, between about 87% and about 91%, wherein the composition further comprises, as a percentage by weight:
between about 0.13% and about 0.14% of a sweetener; and
between about 2% and about 3% of dried broth;
wherein the flavoring is, as a percentage by weight of the composition, between about 6% and about 10%.

10. The comestible product of claim 9, wherein the sweetener is comprised of, as a percentage by weight of the composition:
between about 0.065% and about 0.070% of a first sweetener; and
between about 0.065% and about 0.070% of a second sweetener;
wherein the first sweetener and the second sweetener are different types of sweeteners.

11. A comestible product including a composition comprising at least two of:
a dried protein;
a dried vegetable;
a dried fruit;
a dried broth;
a carbohydrate; and
a flavoring.

12. The comestible product of claim 11, wherein the composition comprises at least three of:
the dried protein;
the dried vegetable;
the dried fruit;
the dried broth;
the carbohydrate; and
the flavoring.

13. The comestible product of claim 11, wherein the composition comprises at least four of:
the dried protein;
the dried vegetable;
the dried fruit;
the dried broth;
the carbohydrate; and
the flavoring.

14. The comestible product of claim 11, wherein the composition comprises the dried protein, the dried vegetable, and the flavoring.

15. The comestible product of claim 14, wherein the composition comprises, as a percentage by weight:
between about 30% and about 91% of the dried protein;
between about 10% and about 50% of the dried vegetable; and
between about 3% and about 40% of the flavoring;
wherein the composition, as a percentage by weight, does not exceed 100%.

16. The comestible product of claim 15, wherein the flavoring is comprised of a sweetener and a flavoring.

17. The comestible product of claim 11, wherein the composition comprises, as a percentage by weight:
between about 70% and about 91% of the dried protein;
between about 10% and about 21%% of the dried vegetable; and
between about 4% and about 10% of the flavoring;
wherein the composition, as a percentage by weight, does not exceed 100%.

18. The comestible product of claim 17, wherein the composition further comprises, as a percentage by weight, between about 2% and about 3% of the dried broth.

19. The comestible product of claim 18, wherein the flavoring is comprised of a sweetener and a flavoring.

20. The comestible product of claim 11, wherein the composition comprises, as a percentage by weight:
between about 30% and about 91% of the dried protein;
between about 2% and about 50% of the dried broth; and
between about 3% and about 40% of the flavoring;
wherein the composition, as a percentage by weight, does not exceed 100%.

21. The comestible product of claim 11, wherein the composition comprises, as a percentage by weight:
between about 87% and about 91% of the dried protein;
between about 2% and about 3% of the dried broth; and
between about 6% and about 10% of the flavoring;
wherein the composition, as a percentage by weight, does not exceed 100%.

22. The comestible product of claim 21, wherein the flavoring comprises, as a percentage of weight of the composition, between about 0.06% and about 0.14% of a sweetener.
